(19) United States
(12) Patent Application Publication
(10) Pub. No.: US 2019/0306637 A1
(43) Pub. Date: Oct. 3, 2019

(54) A Hearing Device,A Hearing Device System and A Method Performed in A Hearing Device

(71) Applicant: Sonova AG, Staefa (CH)

(72) Inventors: Sahba Aazami, Fournex (CH); Joel Lauber, Staefa (CH)

(73) Assignee: Sonova AG, Staefa (CH)

(21) Appl. No.: 16/078,106

(22) PCT Filed: Mar. 8, 2016
(86) PCT No.: PCT/EP2016/054839

§ 371 Date: Aug. 21, 2018

(51) Int. Cl. H04R 25/00

(52) U.S. Cl. CPC H04R 25/65; H04R 2225/33

(57) ABSTRACT

The present invention relates to a hearing device (10) comprising a processor (16) and a control unit (14) connected to each other. The hearing device (10) further comprises at least one light emitting diode (12) operatively connected to the control unit (14), wherein said control unit (14) is adapted to switch the operational mode of the at least one light emitting diode (12) such to operate in a transmittal mode or a reception mode.

### TECHNICAL FIELD

The present invention is related to a hearing device, a hearing device system and a method performed in a hearing device.

### BACKGROUND OF THE INVENTION

Hearing devices are typically used to improve the hearing capability or communication capability of a user. A hearing device may pick up the surrounding sound with a microphone of the hearing device, process the microphone signal thereby taking into account the hearing preferences of the user of the hearing device and provide the processed sound signal into an ear canal of the user via a miniature loudspeaker, commonly referred to as a receiver. A hearing device may also receive sound from an alternative input such as an induction coil or a wireless interface. A hearing device may comprise a light emitting diode for signalling status information to the user.

Hearing aides are hearing devices, which are worn at the ear of a user. The sound processing is optimized in order to compensate for hearing impairment of the user. To that scope the sound signal is modified by the processor. This modifying of the sound signal comprises frequency and amplitude adjustments and may further comprise shifting of frequencies or other complex signalling transformations. This modifying of the sound signal is based on a set of parameters which is carefully determined during a so-called fitting session in order to compensate for individual hearing loss of the user. These parameters are called fitting data and are stored in a memory of the hearing aid. This memory can also contain program code for sound processing algorithms or program code which is used for the operation of the hearing aid. All these parameters or codes are referred to as data or information. Some of the data needs to be updated from time to time. Fitting a hearing device requires a bidirectional connection between a fitting station and the hearing aid. A user may wish to control his hearing device remotely or to obtain information from the hearing device. This requires a bidirectional connection between a remote control and the hearing device.

With the advent of rechargeable technology used in the hearing instrument domain, several technical challenges need to be addressed. One such challenge presents itself when the system utilises contactless or rather wireless charging or is extended to include thereof. Various standards are already in place for devices that fall in the higher power consumption class such as Laptop PC's and mobile phones. When hearing instruments are considered, the power parameters become critical, and pose a challenge to the already established standards, in that the requirement for size and self-consumption (efficiency) of the additional circuits remain strictly in the low power (micro even nano ampere) region.

The contactless or rather wireless charging environment, in most cases, imposes a requirement for universality. This means that a transmitting device needs to be capable of transferring power to receivers with different capabilities (voltage, current, etc.). This in turn creates a requirement for communication between the transmitter and the receiver part in order to establish the capabilities at the receiving end. Present standards and implementations rely on modulation techniques, superimposed on the energy transfer circuits and coils in order to establish a communication link for transfer of digital data. If information needs to be transmitted from the hearing device to the charging device (charging station) this would require the communication link to be bidirectional.

In order to simplify the setup of a communication between a hearing device and an accessory device, wireless solutions are preferred. Communication may be based on electromagnetic or optical coupling. Optical coupling is robust with regard to electromagnetic disturbances.

As mentioned above, in the hearing instrument domain, the important criterion of size and consumption must be strictly observed. Therefore, providing additional elements such as required by the receiving circuits is adverse.

It is therefore an object of the present invention to propose a bidirectional optical interface to a hearing device with reduced space requirements. It is further object of the invention to provide improved wireless charging capabilities. It is further object of the invention to propose a hearing device system comprising such a hearing device. Furthermore, it is an object of the invention to propose a method performed in such a hearing device.

### SUMMARY OF THE INVENTION

The present invention is directed to a hearing device comprising a processor and a control unit connected to each other, further comprising at least one light emitting diode operatively connected to the control unit, wherein said control unit is adapted to switch the operational mode of the at least one light emitting diode such to operate in a transmittal mode or a reception mode.

The inventive hearing device advantageously exploits the light emitting diode LED to operate as an output device as well as an input device. Therefore, advantageously, the present invention allows reusing of existing components comprised by the hearing device, i.e. reusing of the light emitting diode, with minimum additional elements, in order to provide a bidirectional optical communication link for digital data transfer from an external device, i.e. a charging device, a remote control or a fitting station, to the hearing device which may comprise a memory. While light emitting diodes are known to be light emitters, it has been observed that they can also be used as light receivers. In other words, signalling is also possible by using the light emitting diode as a receiver. Using an LED as an optical receiver may not provide high bandwidth as with dedicated optical receivers. Therefore an engineer might not consider such a solution. This feature encompasses an arrangement for signal conditioning as well as an input circuit. The inventive reuse or rather dual function of the at least one light emitting diode results in cost savings of the hearing device as a whole. Further, advantageously, the omission of a further (receiving) component allows to safe space of the hearing device.

The proposed hearing device comprises a control unit connected to the light emitting diode, adapted to, in the transmittal mode, drive the light emitting diode to optically transmit hearing device related operational states to a receiving module. This embodiment of the hearing device allows to use the LED as a transmitting means in order to optically transmit hearing device related operational states to the receiving module, e.g. a charging device.

In a further embodiment the control unit further comprises a buffer coupled to the light emitting diode, adapted to convert voltage variations of the light emitting diode into a digital code.

Using the LED both as a transmitting means as well as a receiving means allows to transmit and receive data related to the hearing device. This data can comprise information which can be used to program (or read) internal registers or a memory of the hearing device with information. In other words, an external modulated light source (e.g. comprised by the charging device) can be used to send digital data to the hearing device.

In a further embodiment the hearing device further comprises a memory adapted to register an information comprised in the digital code, said information comprises at least one of a hearing device ID, hearing device voltage capabilities, hearing device current capabilities, hearing device fitting data, hearing device program code, and an encryption/decryption keyword to lock/unlock at least one of a plurality of hearing device functions. Hence, an external modulated light source can be used to send digital data to the hearing device.

In a further embodiment the hearing device is an In-The-Ear ITE hearing aid or a Behind-The-Ear BTE hearing aid.

In a further embodiment the hearing device comprises a rechargeable battery and a power module for charging said rechargeable battery by a charging device, in particular a wireless charging device. Hence, improved wireless charging capabilities are provided. Charging can be achieved by means of inductive charging.

Moreover, the present invention is directed to a hearing device system comprising a hearing device according to one of claims 1 to 5 and an accessory device, said accessory device comprising an optical receiver and an optical transmitter, said hearing device system is adapted to switch between data transfer from the hearing device to the accessory device and data transfer from the accessory device to the hearing device.

The accessory device can comprise an optical receiver and an optical transmitter. While in the hearing device according to the invention an LED is shared for both sending and receiving data through an optical link, the accessory device may use dedicated optical transmitters or receivers. A transmitter can be an LED or a laser or any light source which can be modulated. A receiver can be a photodiode, a phototransistor, an LED in receiving mode or any other component which can be used to detect a modulation of incident light.

In an aspect the hearing device comprises a rechargeable battery. The inventive solution may in this case advantageously be used to transmit data regarding power capabilities of the hearing device or for controlling the charging process of said battery.

In a further embodiment of the hearing device the accessory device is a charging device, in particular a wireless charging device. The hearing device in this case may further comprise a power management unit for charging the battery of the hearing device. The charging process may comprise controlling a charging current and/or voltage. Such parameters can be exchanged between the charging device and the hearing device. In an aspect of the hearing device system the accessory device further comprises a buffer connected to said light emitting diode, adapted to, in the reception mode, convert an optical signal, which is received from the hearing device via the light emitting diode, into a digital code.

In an embodiment of the hearing device system the accessory device further comprises a memory for storing hearing device related data to be transmitted to the hearing device.

In an embodiment of the hearing device system the hearing device related data comprises information relating to at least one of a hearing device ID, hearing device voltage capabilities, hearing device current capabilities, hearing device fitting data, hearing device program code, and an encryption/decryption keyword to lock/unlock at least one of a plurality of hearing device functions.

Moreover, the present invention is directed to a method performed in a hearing device, wherein the hearing device comprises a processor and a control unit connected to each other, further comprising at least one light emitting diode operatively connected to the control unit, wherein said method comprises the step of switching operational mode of the at least one light emitting diode such to operate in a transmittal mode or a reception mode.

In an embodiment the method further comprises, in the transmittal mode, driving the light emitting diode to optically transmit hearing device related data to a receiving module, and, in the reception mode, converting optical signals, which are received from the light emitting diode, into a digital code.

In an embodiment the method further comprises the step of coupling the hearing device to an accessory device, said accessory device comprising an optical receiver and an optical transmitter, wherein said coupling comprises optically transmitting information between the hearing device and the accessory device.

In an embodiment of the method the information comprises at least one of a hearing device ID, hearing device voltage capabilities, hearing device current capabilities, hearing device fitting data, hearing device program code, and an encryption/decryption keyword to lock/unlock at least one of a plurality of hearing device functions.

In an embodiment of the method the hearing device further comprises a rechargeable battery and a power module for charging the rechargeable battery, wherein the accessory device is a charging device, wherein said coupling further comprises connecting said charging device to the power module.

In an embodiment the method comprises the step of performing a charging process, wherein said charging process is controlled by said optically transmitted information.

It is expressly pointed out that any combination of the above mentioned embodiments is subject of further possible embodiments. Only those embodiments are excluded that would result in a contradiction.

### BRIEF DESCRIPTION OF THE DRAWINGS

The present invention is further described with reference to the accompanying drawing illustrating an embodiment which is to be considered in connection with the following detailed description. What is shown in the figures is:

FIG. 1: schematically depicts a hearing device comprising a light emitting diode (LED) which is prepared to provide a bidirectional optical interface to an accessory device,

FIG. 2: schematically depicts a hearing device embodied as an In-The-Ear (ITE) hearing device comprising an LED, and

FIG. 3: schematically depicts a hearing device system including an accessory device embodied as a wireless charging device and a hearing device embodied as a Behind-The-Ear (BTE) hearing device placed into the wireless charging device.

### DETAILED DESCRIPTION OF THE INVENTION

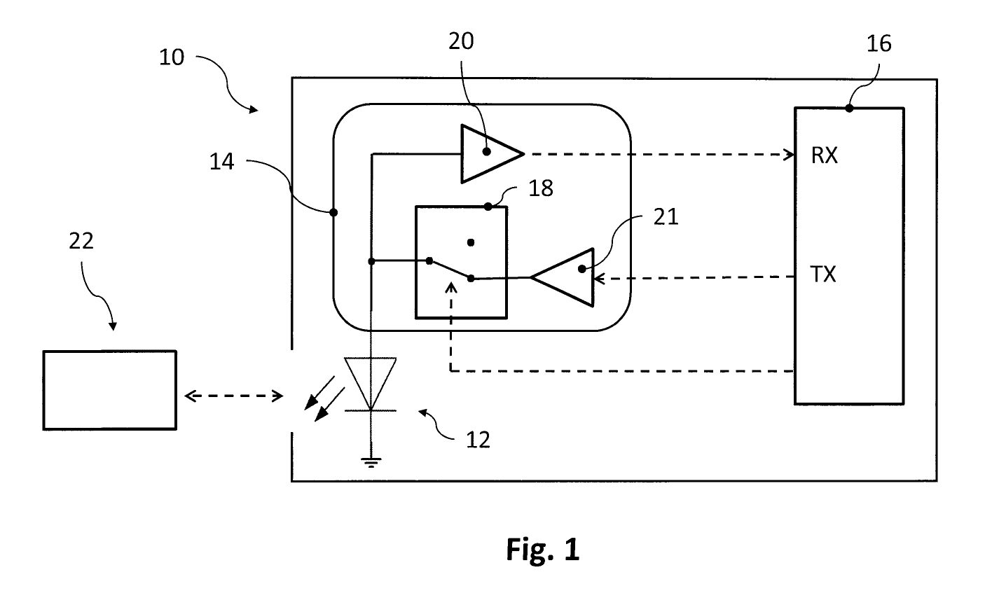

FIG. 1 schematically depicts a hearing device 10 according to an embodiment of the invention. The hearing device 10 comprises a light emitting diode (LED) 12, a control unit 14 and a processor 16. The processor 16 may comprise or be connected to a memory (not separately shown). The control unit 14 comprises a switch 18 which may connect the LED 12 to a data output TX of the processor 16. Optionally the control unit 14 may comprise an LED-driver (not separately shown). Once the switch 18 connects the LED 12 to the data output TX of the processor 16 the hearing device 10 is in transmission mode. Once the switch 18 disconnects the LED 12 from the data output TX of the processor 16 the hearing device 10 is in receiving mode.

The hearing device 10 comprises a buffer 20 coupled to the LED 12. Said buffer 20 is adapted to convert a voltage of the LED 12 into a digital code, in particular a binary code, and thereby provides a data stream RX data which is fed to a data input RX of the processor 16 or to the associated memory. The buffer 20 may comprise an amplifier or a comparator (not separately shown) in order to condition the electrical signal from the LED 12. The control unit 14 may also be prepared to disconnect the buffer 20 from the LED 12 if the hearing device is in transmission mode. This is however in many cases not necessary, in particular if the buffer 20 has a high input impedance. In the embodiment as shown in FIG. 1 the control unit 14 further comprises an LED-driver 21 coupled between a data output TX of the processor 16 and the switch 18.

The switch 18 is steered or rather controlled by the processor 16. The processor 16 therefore is controlling the operational mode of the hearing device 10. The RX, TX and control operational mode connections may physically be realized by separate wires. However, the connections may also use shared electrical connections.

FIG. 1 also shows an accessory device 22 (to be described in further detail in the following), which is capable of receiving or transmitting data optically. The accessory device 22 can comprise an optical receiver and an optical transmitter. In principle any technique may be used to realize the optical interface of the accessory device 22.

According to the present invention, the same LED 12 can be operated as optical sender (TX) or receiver (RX). When operated as sender the LED 12 is controlled by the processor 16 (a power driver may provide the LED current). When operated as receiver the LED 12 and processor 16 are disconnected—the voltage at the LED 12 varies with incident light, the voltage is then amplified and converted by the buffer 20 thus providing a digital data stream. The operating mode is controlled by the processor 16.

It is to be noted that, while the (typical) electrical symbol of an LED is a diode and an indicator of emitted light, the LED may not only emit light, but also acts as a receiving element. However, in the drawings of the present application, the (typical) electrical symbol is maintained.

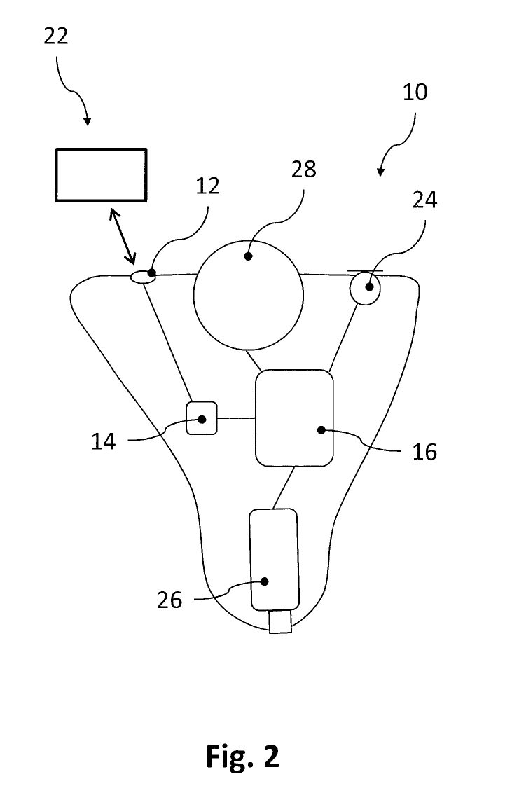

FIG. 2 shows an exemplary embodiment of the hearing device 10 according to the invention embodied as an In-The-Ear (ITE) hearing device 10. The invention is beneficial for ITE devices 10, because they need to be particularly small. The ITE device 10 comprises the LED 12 and the control unit 14. In the ITE hearing device 10 as shown in FIG. 2, one and the same LED 12 is used as optical transmitter and/or optical receiver. The control unit 14 is connected to the processor 16. The connection may comprise TX and RX and control lines. The processor 16 is connected to a microphone 24, a miniature loudspeaker 26 and a battery 28. The ITE device 10 is optically connected to the accessory device 22, which is capable of receiving or transmitting data optically from and/or to the ITE device 10. The accessory device 22 comprises an optical receiver and a transmitter (not shown). The optical interface between the accessory device 22 and the ITE device 10 can be realized by any technique.

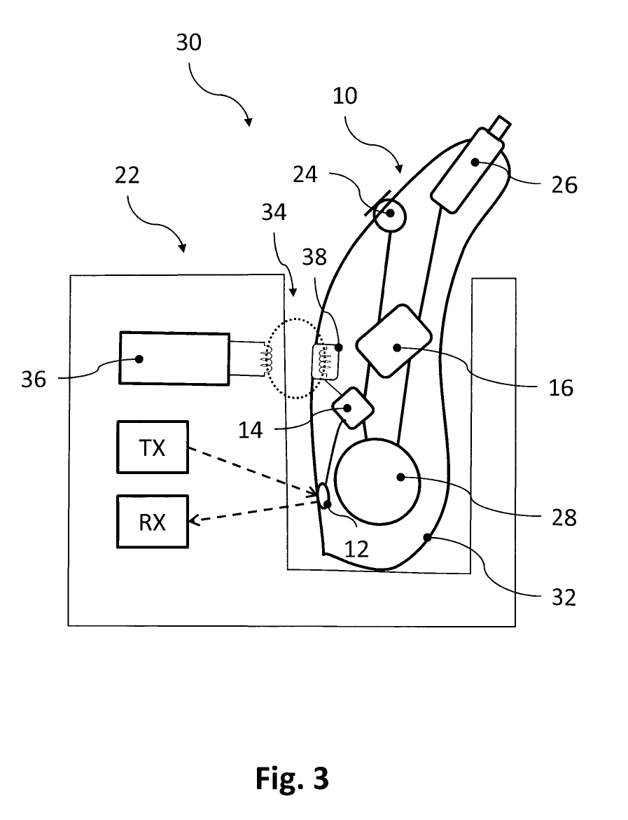

FIG. 3 schematically depicts a hearing device system 30 comprising the hearing device 10 and the accessory device 22. In the example shown the hearing device 10 is a Behind-The-Ear (BTE) hearing device 10 and the accessory device 22 is embodied as the wireless charging device 22. The devices 10,22 are optically coupled to each other in order to allow exchange of information. The hearing device 10 comprises the control unit 14, one port thereof being connected to the light emitting diode (LED) 12 which in the example is mounted to a housing 32 of the hearing device 10 such to be exposed to the outside. Said control unit 14 is adapted to, in the transmittal mode, drive the LED 12 to optically transmit hearing device related information to the wireless charging device 22. Further, said control unit 14 is adapted to, in the reception mode, receive digital data from the wireless charging device 22. Hence, the hearing device 10 and the charging device 22 can exchange information by means of the LED 12 which is adapted to both transmit and receive data. The wireless charging device 22 of the example comprises an optical transmitter TX and an optical receiver RX as separate components. Since the wireless charging device 22 may be much larger than the BTE hearing device 10 there is no space limitation as in the BTE hearing device 10. This allows the wireless charging device 22 to use dedicated sending and receiving components (TX and RX). In the wireless charging device 22 it would however also be possible to use a single component for sending and receiving.

The information mentioned above can comprise a hearing device ID, information about voltage and/or current capabilities of the hearing device 10, etc. In a further example, data transmitted from the wireless charging device 22 to the BTE hearing device 10 can comprise a digital key used to lock or unlock at least one of a plurality of hearing device related functions. Therefore, at least a plurality of hearing device functions can be locked or rather unlocked remotely by means of the wireless charging device 22. While not explicitly shown, the wireless charging device 22 can comprise:
means for generating data;
means for analysing or rather conditioning said generated data;
means for receiving said generated data; and/or
means for registering the received data.

In the hearing device 10 the data is generated by the processor 16 or received or read from a memory or written to a memory (not shown). The processor 16 is connected to the microphone 24 and the miniature loudspeaker 26 and processes sound according to program code and parameters which are stored in the memory. The BTE device 10 comprises the LED 12 and the control unit 14, which is connected to the processor 16. The processor 16 is connected the battery 28, which in the embodiment shown is a rechargeable battery.

In the hearing device system 30 as shown in FIG. 3, the wireless charging device 22 might be commonly used to charge the hearing device 10. In the shown embodiment the hearing device system 30 comprises an inductive charging assembly 34 adapted to charge the hearing device 10. The inductive charging assembly 34 comprises a power supply unit (PSU) 36 comprised by the wireless charging device 22 and a power module 38 comprised by the hearing device 10. Hence, the rechargeable battery 28 of the hearing device 10, once placed into the wireless charging device 22, can be charged via inductive charging. Both the power supply unit 36 as well as the power module 38 can comprise inductions coils, respectively.

The hearing device system 30 is adapted to switch between data transfer from the hearing device 10 to the wireless charging device 22 and data transfer from the wireless charging device 22 to the hearing device 10. In the following, data transmission/reception, i.e. data exchange between the hearing device 10 and the wireless charging device 22 will be explained in more detail.

In a first mode, hearing device related data stored in a memory (not shown) of the wireless charging device 22 is transmitted to the hearing device 10. Therefore, the data is retrieved from the memory and passed to the optical transmitter TX (optical sender) which optically transmits the data to the LED 12 of the hearing device 10. The LED 12 is disconnected from the data output of the processor 16 but it is connected to the input of the buffer of the control unit 14 (refer to FIG. 1). In this first mode as described above, the hearing device system 30 enables data transfer from the wireless charging device 22 to the hearing device 10. The LED 12 of the hearing device 10 operates in a reception mode.

In a second mode, digital code is stored in a memory (not separately shown) of the hearing device 10 and intended to be sent to the wireless charging device 22. This digital code is passed to the LED 12 of the hearing device 10 via the switch (not separately shown) comprised by the control unit 14 (refer to FIG. 1). The LED 12 optically transmits said digital code to the optical receiver RX of the wireless charging device 22. The digital code gathered from the hearing device 10 is stored in the wireless charging device 22 as digital code. In this mode, the hearing device system 30 enables data transfer from the hearing device 10 to the wireless charging device 22. In this mode, the LED 12 of the hearing device 10 operates in a transmittal mode, while the wireless charging device 22 operates in a reception mode.

In the hearing device 10 the LED 12 is connected to the data output TX (refer to FIG. 1) of the processor 16. The LED 12 is used to signal certain operational states or some data stored in the memory of the hearing device 10 to the wireless charging device 22.

The hearing device 10 at least from time to time operates in the receiving mode. In this mode the buffer (refer to FIG. 1) may detect the presence of an optical signal at the LED 12. If a signal is detected it can be analyzed whether the signal contains an information or not. The information may trigger the hearing device 10 to enter into transmission mode and to send data through the LED 12.

It has been shown that the LED 12 can be used as optical receiver or as optical transmitter. This enables the provision of a bidirectional, optical communication link between the hearing device 10 and the accessory device 22. This dual use of the LED 12 allows reduced costs and enables reduced space of the hearing device 10.

The present invention enables to keep additional circuitry to a minimum in order to achieve overall efficiency goal. Furthermore, the wireless charging device 22 advantageously maintains universality criterion, which means the present invention allows the wireless charging device 22 to charge different hearing devices with different capabilities. This ability allows further cost reductions.

Further functionalities of the inventive hearing device may be implemented. The invention enables the hearing device to measure the intensity of ambient light using the LED. An adaptation of the LED-brightness can thus easily be realized in dependence of the measured ambient light. Also an adaptation of the audio processing parameters in dependence of the measured ambient light is possible. A recognition of a coverage of the LED by a user's finger would allow the detection of a gesture, thus proving a simple user interface. A modulation light received by the LED could be detected. This would allow to receive an audio signal, which may be encoded in the light.

1-15. (canceled)

16. A hearing device, the hearing device comprising:
a control unit;
a light emitting diode electronically coupled to the control unit,
wherein control unit is configured to select a transmittal mode or a reception mode for the light emitting diode, and
wherein the control unit further comprises a buffer electronically coupled to the light emitting diode configured to convert voltage variations of the light emitting diode into a digital code.

17. The hearing device of claim 16, the hearing device further comprising:
a memory storing information associated with the digital code, the information comprises at least one of the following:
hearing device ID;
hearing device voltage for charging;
hearing device capabilities;
hearing device fitting data;
hearing device program code; or
an encryption/decryption keyword to lock/unlock at least one of a multiple of hearing device functions.

18. The hearing device of claim 16, wherein the hearing device is an In-The-Ear (ITE) hearing aid or a Behind-The-Ear (BTE) hearing aid.

19. The hearing device of claim 16, wherein the hearing device further comprises:
a rechargeable battery; and
a power module for charging the rechargeable battery.

20. A hearing system, the hearing system comprising:
a hearing device, the hearing device comprising:
a control unit;
a light emitting diode electronically coupled to the control unit,
wherein control unit is configured to select a transmittal mode or a reception mode for the light emitting diode,
wherein the control unit further comprises a buffer electronically coupled to the light emitting diode configured to convert voltage variations of the light emitting diode into a digital code; and
an accessory device,
wherein the accessory device comprises an optical receiver and an optical transmitter, and
wherein the hearing system is configured to switch between data transfer from the hearing device to the accessory device and data transfer from the accessory device to the hearing device.

21. The hearing system of claim 20, wherein the accessory device is a charging device.

22. The hearing system of claim 20, wherein the accessory device further comprises a memory for storing hearing device related data to be transmitted to the hearing device.

23. The hearing system of claim 20, wherein the digital code is associated with at least one of the following:
a hearing device ID,
hearing device voltage capabilities,
hearing device current capabilities,
hearing device fitting data,
hearing device program code, or
an encryption/decryption keyword to lock/unlock at least one of a plurality of hearing device functions.

24. The hearing system of claim 20, wherein the hearing device is an In-The-Ear (ITE) hearing aid or a Behind-The-Ear (BTE) hearing aid.

25. The hearing system of claim 20, wherein the hearing device further comprises a rechargeable battery; and
a power module for charging the rechargeable battery.

26. A method for communicating with a hearing device, the method comprising:
switching a hearing device from a transmittal mode to a reception mode or from the reception mode to the transmittal mode;
driving the light emitting diode to optically transmit hearing device related data based on a digital code; and
converting received optical signals into the digital code.

27. The method of claim 26, wherein the digital code is associated with at least one of the following:
a hearing device ID;
hearing device voltage capabilities;
hearing device current capabilities;
hearing device fitting data;
hearing device program code; or
an encryption/decryption keyword to lock/unlock at least one of a plurality of hearing device functions.

28. The method of claim 26, wherein the digital code is associated with information for wirelessly charging the hearing device.
